(19) United States
(12) Patent Application Publication
(10) Pub. No.: US 2011/0059346 A1
(43) Pub. Date: Mar. 10, 2011

(54) COOLING SYSTEM AND BATTERY COOLING SYSTEM

(75) Inventors: Ji-young Jeong, Bucheon-si (KR); Dong-Kwan Kim, Hwaseong-si (KR); Meen-seon Paik, Seongnam-si (KR); Tae-sang Park, Suwon-si (KR)

(73) Assignee: Samsung Electronics Co., Ltd., Suwon-si (KR)

(21) Appl. No.: 12/721,062

(22) Filed: Mar. 10, 2010

(30) Foreign Application Priority Data
Sep. 7, 2009 (KR) 10-2009-0083985

(51) Int. Cl. H01M 10/50; F25B 30/00; F25D 17/02; F28D 15/02; F28D 21/00

(52) U.S. Cl. 429/120; 62/324.6; 62/434; 165/104.21; 165/104.31; 165/104.33

(57) ABSTRACT

A cooling system includes a heat pipe for contacting a heated member and absorbing heat from the heated member, and a first heat exchange unit for containing a refrigerant that is heated by absorbing the heat from a heat emitting part. Also, the heated member cooling system includes a second heat exchange unit for containing the refrigerant entered from the first heat exchange unit and cooling the refrigerant, and for emitting the cooled refrigerant to the first heat exchange unit.

### CROSS-REFERENCE TO RELATED APPLICATION

This application claims the benefit of Korean Application No. 10-2009-0083985, filed in the Korean Intellectual Property Office on Sep. 7, 2009, the disclosure of which is incorporated herein by reference.

### BACKGROUND

1. Field

The present disclosure relates to a heated member cooling system for prevention of overheating of a heated member including a battery cell, a fuel cell, a semiconductor chip or the like.

2. Description of the Related Art

A battery or fuel cell used in a high-output device, such as an automobile or the like, may overheat due to having high heating value. In such circumstances, it may be necessary to supply the battery or fuel cell with a cooling device to prevent overheating. It may be inadequate to cool a heated member having a high heating value using a cooling device of an air cooling type, and mainly, the heated member may be cooled by using a cooling device of a liquid cooling type. Thus, it is necessary to consider efficiency of a cooling system of a liquid cooling type.

### SUMMARY

Aspects of the present invention include a cooling system and a battery cooling system that include a heat pipe and a heat exchanger of a liquid cooling type, whereby cooling efficiency is improved.

Aspects of the present invention also include a cooling system and a battery cooling system having structures simplified to be manufactured in a compact manner.

According to an aspect of the present invention, a cooling system is provided. The cooling system includes at least one heat source; at least one heat pipe including, on one side, a heat absorbing part contacting the at least one heat source to absorb heat from the heated member, and on another side, a heat emitting part to emit the heat absorbed by the heat absorbing part; a first heat exchange unit to contain a refrigerant heated by absorbing the heat from the heat emitting part; and a second heat exchange unit to receive the refrigerant from the first heat exchange unit and cooling the refrigerant, and to emit the cooled refrigerant to the first heat exchange unit.

According to another aspect of the present invention, the refrigerant in a liquid state may be partly vaporized in the first heat exchange unit, and the partly vaporized refrigerant may be condensed into a liquid again in the second heat exchange unit.

According to another aspect of the present invention, the at least one heat source may include a flat surface, and the heat absorbing part of the heat pipe may include a flat surface in surface contact with the flat surface of the at least one heat source.

According to another aspect of the present invention, the at least one heat pipe may have a plate shape.

According to another aspect of the present invention, the at least one heat source may comprise a plurality of the heat sources separated from each other, and the at least one heat pipe may include a plurality of the heat pipes, and each of the plurality of the heat pipes may be interposed between corresponding ones of the plurality of the heat sources.

According to another aspect of the present invention, a plurality of the heat emitting parts of the plurality of the heat pipes may be separated from each other, and each of the plurality of the heat emitting parts may be inserted into the first heat exchange unit, and each of the plurality of the heat emitting parts may directly contact the refrigerant.

According to another aspect of the present invention, the heat emitting part may be bent and extended from the heat absorbing part, and a side surface of the heat emitting part may be in contact with an external side surface of the first heat exchange unit.

According to another aspect of the present invention, the first heat exchange unit may include a container containing the at least one heat source and the at least one heat pipe, an inlet hole through which the refrigerant enters the container, and an outlet hole through which the refrigerant is emitted from the container.

According to another aspect of the present invention, the second heat exchange unit may be formed in such that the heat transfers from the partly vaporized refrigerant to air.

According to another aspect of the present invention, the refrigerant may include water (H2O).

According to another aspect of the present invention, the cooling system may further include a pump to circulate the refrigerant between the first heat exchange unit and the second heat exchange unit.

According to another aspect of the present invention, the at least one heat source may include a battery cell.

According to another aspect of the present invention, a battery cooling system is provided. The battery cooling system includes a plurality of plate-shaped battery cells; a plurality of plate-shaped heat pipes alternately disposed between the plurality of battery cells, each including a heat absorbing part and a heat emitting part, wherein a plurality of the heat absorbing parts are in surface contact with the plurality of battery cells so as to absorb heat; a liquid-cooled-type heat exchanger to cool the heat emitting part with a liquid refrigerant; and an air-cooled-type heat exchanger to receive a refrigerant at a first temperature from the liquid-cooled-type heat exchanger, to air-cool the refrigerant to a second temperature lower than the first temperature, and to supply the refrigerant at the second temperature to the liquid-cooled-type heat exchanger.

According to another aspect of the present invention, the refrigerant in the liquid-cooled-type heat exchanger may be in direct contact with the heat emitting part.

According to another aspect of the present invention, the heat emitting part may be in contact with an external side surface of the liquid-cooled-type heat exchanger in which the refrigerant flows.

According to another aspect of the present invention, the plurality of battery cells and the plurality of heat pipes may be soaked in the refrigerant in the liquid-cooled-type heat exchanger.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram of a heated member cooling system according to an embodiment of the present invention;

FIG. 2 is a diagram of a portion of a heated member cooling system according to another embodiment of the present invention;

FIG. 3 is a diagram of a portion of a heated member cooling system according to another embodiment of the present invention; and

FIG. 4 is a diagram of a portion of a heated member cooling system according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

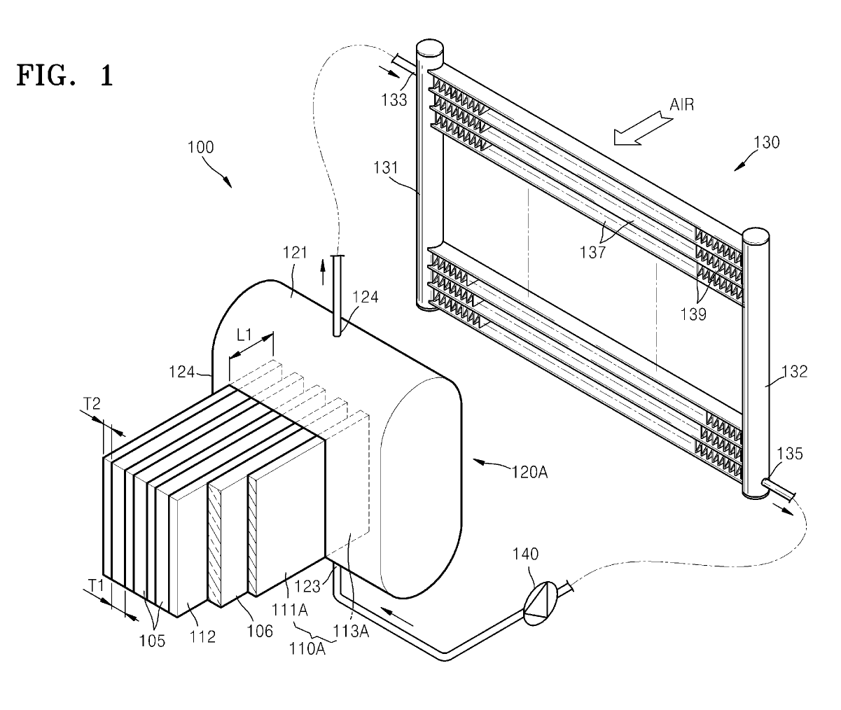

FIG. 1 is a diagram of a heated member cooling system 100 according to an embodiment of the present invention. The heated member cooling system 100 includes a plurality of heated members 105, a plurality of heat pipes 110A, a first heat exchange unit 120A, and a second heat exchange unit 130. The heated member cooling system 100 is a system in which a refrigerant circulates through the first heat exchange unit 120A and the second heat exchange unit 130; absorbs heat from the heated members 105 in the first heat exchange unit 120A in such a manner that the refrigerant, in a liquid state, is partly vaporized; and emits the heat to air in the second heat exchange unit 130 in such a manner that the partly vaporized refrigerant is condensed into a liquid.

Each heated member 105 may be a battery cell, a fuel cell, or a semiconductor chip, although the heated members 105 are not limited thereto. For example, the heated members 105 may be battery or fuel cells providing power to an automobile. The heated members 105 are separated from each other. Each of the heated members 105 may be plate shaped and have a flat surface 106.

Each heat pipe 110A includes, on one side, a heat absorbing part 111A arranged to contact the heated members 105 to absorb heat from the heated members 105, and on another side, a heat emitting part 113A arranged to emit the heat absorbed by the heat absorbing part 111A and then delivered in the heat emitting part 113A.

The heat pipes 110A contain a working fluid that is vaporized in the heat absorbing parts 111A and that is condensed in the heat emitting parts 113A. The heat pipes 110A may be, for example, capillary-force type, a gravity type, a centrifugal-force type, an electromagnetic-force type, or the like. Generally, the heat pipes 110A may be the capillary-force type, although the heat pipes 110A are not limited thereto. The capillary-force type heat pipes 110A the include a mesh or groove-shaped capillary structure called a wick. Positioning of the heat absorbing part 111A is not limited to any particular arrangement or position.

The heat pipes 110A of the gravity type do not include a capillary structure, and thus they are called a wick-less heat pipe or a thermosyphon. In the gravity type heat pipes 110A, the working fluid condensed in the heat emitting parts 113A returns to the heat absorbing parts 111A by gravity. To facilitate this, the heat absorbing parts 111A are generally formed at a lower position than that of the heat emitting parts 113A. Table 1 indicates main types of the working fluid according to working temperatures of the heat pipes 110A.

TABLE 1

| Working temperature (° C.) | Main types of working fluid |
|---|---|
| from about −270 to about −70 | helium, argon, krypton, nitrogen, |
| (very low temperature) | methane |
| from about −70 to about 200 | water, Freon-based refrigerant, |
| (low temperature) | ammonia, acetone |
| from about 200 to about 500 | naphthalene, sulfur, mercury |
| (middle temperature) | |
| from about 500 to about 1000 | cesium, potassium, sodium |
| (high temperature) | |
| equal to or greater than about 1000 | lithium, lead, silver |
| (very high temperature) | |

The heat pipes 110A are interposed between the heated members 105 that are separated from each other. Each of the heat pipes 110A may be plate shaped and have a flat surface 112 so as to be in surface contact with the flat surfaces 106 of the heated members 105.

The first heat exchange unit 120A includes a housing 121, an inlet hole 123 via which a refrigerant is entered to the housing 121, and an outlet hole 124 via which the refrigerant is emitted from the housing 121. The refrigerant entering the housing 121 via the inlet hole 123 is in a liquid state and absorbs heat from the heat emitting part 113A of each heat pipe 110A. Accordingly, at least a portion of the refrigerant in the liquid state is vaporized and then is emitted via the outlet hole 124. Since the inlet hole 123 is formed at a lower part of the housing 121 and the outlet hole 124 is formed at an upper part of the housing 121, the refrigerant flows from the lower part to the upper part in the housing 121 while passing between the heat emitting parts 113A of the heat pipes 110A. The refrigerant may be water (H2O).

The heat emitting parts 113A of the heat pipes 110A are separated from each other. Each heat emitting part 113A is inserted into the housing 121 so as to directly contact the refrigerant of the first heat exchange unit 120A.

In the second heat exchange unit 130, the partly vaporized refrigerant, which is emitted from the first heat exchange unit 120A, emits the heat and then is condensed into a liquid again. The second heat exchange unit 130 may be formed in such a manner that the heat may travel from the partly vaporized refrigerant into air. In the case where the heated member cooling system 100 is applied to an automobile, the refrigerant may be water (or other coolant) to cool an engine, and the second heat exchange unit 130 may be a radiator to condense the water.

The second heat exchange unit 130 includes a first tank 131 and a second tank 132 arranged in parallel, a plurality of tubes 137, and fins 139. The plurality of tubes 137 extend in parallel to each other while connecting the first tank 131 and the second tank 132. The fins 139 that promotes heat emission between the tubes 137. While the refrigerant flows through the tubes 137, heat from the refrigerant travels to air flowing between the tubes 137, and then the vaporized refrigerant is condensed into a liquid again. The second heat exchange unit 130 includes an inlet hole 133 through which the refrigerant enters the heat exchange unit 130 (via the outlet hole 124 of the first heat exchange unit 120A), and an outlet hole 135 through which the condensed refrigerant is emitted from the heat exchange unit 130. The refrigerant that is emitted from the second heat exchange unit 130 via the outlet hole 135 re-enters the first heat exchange unit 120A via the inlet hole 123 of the first heat exchange unit 120A.

The refrigerant re-entering the first heat exchange unit 120A absorbs heat from the heat emitting part 113A of each heat pipe 110A, is at least partly vaporized, and then returns to the second heat exchange unit 130. The heated member cooling system 100 may further include a pump 140 to circulate the refrigerant between the first heat exchange unit 120A and second heat exchange unit 130.

Table 2 shows a result of measurements of temperature changes across the heated members 105 before operating vs. after operating the heated member cooling system of FIG. 1 while changing a horizontal length L1 of the heat emitting part 113A with respect to the heated member 105, the heat pipe 110A, and the first heat exchange unit 120A of FIG. 1. The heated members 105 used for the experiment were battery cells. Water and air were used as refrigerants. A thickness T1 of the heated members 105 was about 25 mm, and a thickness T2 of the heat pipe 110A was about 2.5 mm.

TABLE 2

| | |
|---|---|
| Length of heat | Temperature change at heated member |

| emitting part (mm) | Air | Water |
|---|---|---|
| 10 | 17.7 | 2.0 |
| 25 | 11.5 | 1.3 |
| 50 | 7.6 | 1.5 |
| 75 | 6.0 | 1.2 |
| 100 | 5.4 | 1.1 |

As shown in Table 2, it is possible to see that the temperature change at the heated member 105 before operating vs. after operating was relatively little when the refrigerant was water, compared to the experiment in which the refrigerant was air, and that a heat emission effect increases with the length of the horizontal length L1 of the heat emitting part 113A, since the temperature change decreases as the horizontal length L1 increases.

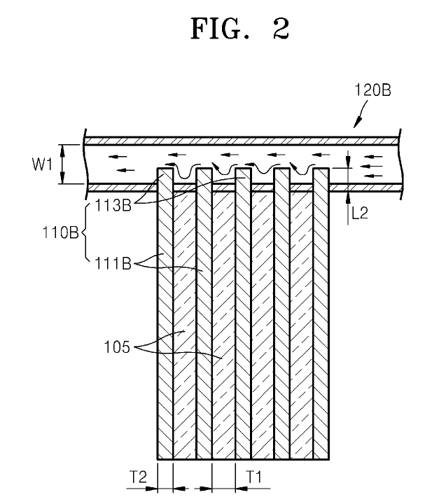

FIGS. 2 through 4 are cross-sectional diagrams of heated member cooling systems each including a plurality of heated members, a plurality of heat pipes, and a first heat exchange unit according to various embodiments of the present invention.

The heated member cooling system in FIG. 2 includes a plurality of plate shaped heated members 105, a plurality of plate shaped heat pipes 110B interposed between the heated members 105, and a first heat exchange unit 120B in which a refrigerant flows. The heated members 105, the heat pipes 1108, and the first heat exchange unit 120B may respectively substitute for the heated members 105, the heat pipes 110A, and the first heat exchange unit 120A in FIG. 1. Each heat pipe 110B includes, on one side, a heat absorbing part 111B arranged to contact the heated members 105 to absorb heat from the heated members 105, and on another side, a heat emitting part 113B arranged to emit the heat absorbed by the heat absorbing parts 111B. The heat emitting parts 113B are inserted into the first heat exchange unit 120B, and thereby directly contact the refrigerant in the first heat exchange unit 1208. The refrigerant in the first heat exchange unit 120B may flow in a single direction across the plurality of heat emitting parts 113B. A horizontal length L2 of the heat emitting parts 113B may be less than that of the heat emitting parts 113A in FIG. 1.

An experiment was performed to measure temperature changes across the heated members 105 before operating vs. after operating the heat member cooling system of FIG. 2 while applying one of two different types of refrigerants to the heated members 105, the heat pipes 110B, and the first heat exchange unit 120B. Water and air were employed as the two types of refrigerants. The heated members 105 used for the experiment were battery cells, a thickness T1 of the heated members 105 was about 25 mm, a thickness T2 of the heat pipes 110B were about 2.5 mm, the horizontal length L2 of the heat emitting parts 1138 was about 1 mm, and a flow passage width W1 of the first heat exchange units 120B was about 2 mm. When the refrigerant was air, the temperature change across the heated members 105 before operating vs. after operating the heated member cooling system of FIG. 2 was about 35° C. When the refrigerant was water, the temperature change across the heated members 105 before operating vs. after operating the heated member cooling system of FIG. 2 was about 5° C. Thus, it is possible to see that a heat emission effect is highly increased when the refrigerant was water, compared to the experiment in which the refrigerant was air.

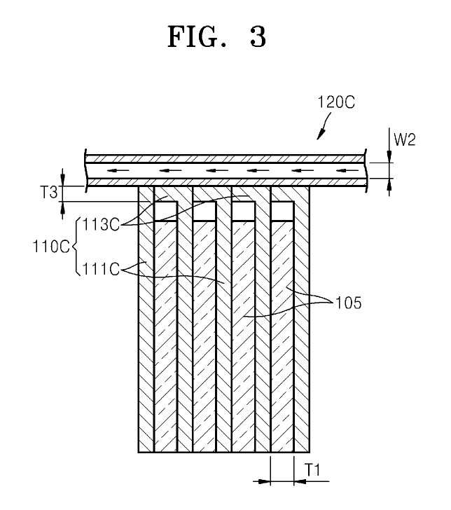

The heated member cooling system in FIG. 3 includes a plurality of plate shaped heated members 105, a plurality of heat pipes 110C interposed between the heated members 105, and a first heat exchange unit 120C through which a refrigerant flows. The heated members 105, the heat pipes 110C, and the first heat exchange unit 120C may respectively also substitute for the heated members 105, the heat pipes 110A, and the first heat exchange unit 120A in FIG. 1. Each heat pipe 110C includes, on one side, a heat absorbing part 111C arranged to contact the heated members 105 to absorb heat from the heated members 105, and on another side, a heat emitting part 113C to emit the heat absorbed by the heat absorbing parts 111C. Some (but not all) of the heat emitting parts 113C are bent and extended from the heat absorbing parts 111C, and a side surface of the bent portions of the heat emitting parts 113C is in contact with an external side surface of the first heat exchange unit 120C. The heat emitting parts 113C are separated from the heated members 105. The heat travels from the heat emitting parts 113C to the first heat exchange unit 120C via a contact surface between the heat emitting parts 113C and the first heat exchange unit 120C. A refrigerant in the first heat exchange unit 120C may flow in a single direction across the plurality of heat emitting parts 113C.

An experiment was performed to measure temperature changes across the heated members 105 before operating vs. after operating the heat member cooling system of FIG. 3 while applying one of two different types of refrigerants, to the heated members 105, the heat pipes 110C, and the first heat exchange unit 120C. As with the prior experiments, water and air were used as the two types of refrigerants. The heated members 105 used for the experiment were battery cells, a thickness T1 of the heated members 105 was about 25 mm, a thickness T2 of the heat pipes 110B was about 2.5 mm, and a flow passage width W2 of the first heat exchange unit 120C was about 2 mm. When the refrigerant was air, the temperature change across the heated members 105 before operating vs. after operating the heated member cooling system of FIG. 3 was about 50° C. When the refrigerant was water, the temperature change across the heated members 105 before operating vs. after operating the heated member cooling system of FIG. 3 was about 6° C. Thus, it is possible to see that a heat emission effect is highly increased when the refrigerant was water, compared to the experiment in which the refrigerant was air.

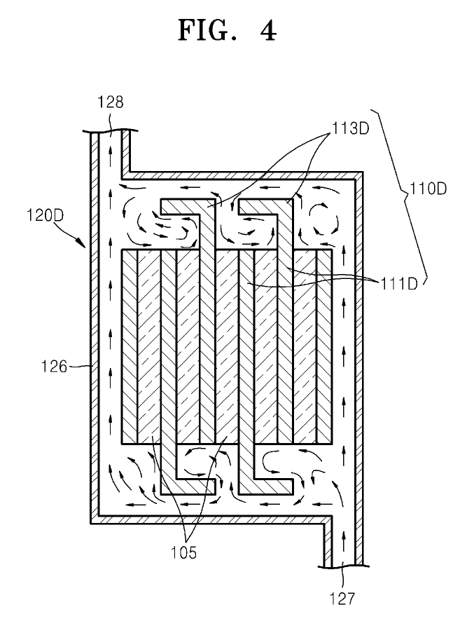

The heated member cooling system in FIG. 4 includes a plurality of plate shaped heated members 105, a plurality of heat pipes 110D interposed between the heated members 105, and a first heat exchange unit 120D including the heated members 105 and the heat pipes 110D. The heated members 105, the heat pipes 110D, and the first heat exchange unit 120D may respectively also substitute for the heated members 105, the heat pipes 110A, and the first heat exchange unit 120A in FIG. 1. Each heat pipe 110D includes, on one side, a heat absorbing part 111D arranged to contact the heated members 105 to absorb heat from the heated members 105, and on another side, a heat emitting part 113D arranged to emit the heat absorbed by the heat absorbing parts 111D. At least some of the heat emitting parts 113D are bent and extended from the heat absorbing parts 111D. The heat emitting parts 113D are not in contact with, but are separated from the heated members 105.

The first heat exchange unit 120D includes a container 126 including the heated members 105 and the heat pipes 110D, an inlet hole 127 through which a refrigerant enters the container 126, and an outlet hole 128 through which the refrigerant is emitted from the container 126. A refrigerant emitted from the second heat exchange unit 130 of FIG. 1 enters the first heat exchange unit 120D via the inlet hole 127, and the refrigerant that is emitted via the outlet hole 128 may be entered into the second heat exchange unit 130 of FIG. 1. The refrigerant in the container 126 may flow from the inlet hole 127 to the outlet hole 128, may absorb heat from the heat emitting parts 113D, and may be partly vaporized.

Although a few embodiments of the present invention have been shown and described, it would be appreciated by those skilled in the art that changes may be made in this embodiment without departing from the principles and spirit of the invention, the scope of which is defined in the claims and their equivalents.

1. A cooling system comprising:
at least one heat source;
at least one heat pipe comprising, on one side, a heat absorbing part contacting the at least one heat source to absorb heat from the at least one heat source, and on another side, a heat emitting part to emit the heat absorbed by the heat absorbing part;
a first heat exchange unit containing a refrigerant heated by absorbing the heat from the heat emitting part; and
a second heat exchange unit to receive the refrigerant from the first heat exchange unit, to cool the refrigerant, and to emit the cooled refrigerant to the first heat exchange unit.

2. The cooling system of claim 1, wherein the refrigerant in a liquid state is partly vaporized in the first heat exchange unit, and the partly vaporized refrigerant condenses into a liquid again in the second heat exchange unit.

3. The cooling system of claim 1, wherein the at least one heat source comprises a flat surface, and the heat absorbing part of the heat pipe comprises a flat surface in surface contact with the flat surface of the at least one heat source.

4. The cooling system of claim 3, wherein the heat pipe has a plate shape.

5. The cooling system of claim 1, wherein:
the at least one heat source comprises a plurality of heat sources separated from each other, and
the at least one heat pipe includes a plurality of the heat pipes, and each of the plurality of the heat pipes are interposed between corresponding ones of the plurality of the heat sources.

6. The cooling system of claim 5, wherein:
a plurality of the heat emitting parts of the plurality of the heat pipes are separated from each other,
each of the plurality of the heat emitting parts is inserted into the first heat exchange unit, and
each of the plurality of the heat emitting parts directly contacts the refrigerant.

7. The cooling system of claim 1, wherein the heat emitting part is bent and extended from the heat absorbing part, and a side surface of the heat emitting part is in contact with an external side surface of the first heat exchange unit.

8. The cooling system of claim 1, wherein the first heat exchange unit comprises:
a container containing the at least one heat source and the at least one heat pipe;
an inlet hole through which the refrigerant enters the container; and
an outlet hole through which the refrigerant is emitted from the container.

9. The cooling system of claim 1, wherein the second heat exchange unit is formed such that the heat transfers from the partly vaporized refrigerant to air.

10. The cooling system of claim 1, wherein the refrigerant comprises water (H2O).

11. The cooling system of claim 1, further comprising a pump to circulate the refrigerant between the first heat exchange unit and the second heat exchange unit.

12. The cooling system of claim 1, wherein the at least one heat source comprises a battery cell.

13. A battery cooling system comprising:
a plurality of plate-shaped battery cells;
a plurality of plate-shaped heat pipes alternately disposed between the plurality of battery cells, each comprising a heat absorbing part and a heat emitting part, wherein a plurality of the heat absorbing parts are in surface contact with the plurality of battery cells so as to absorb heat;
a liquid-cooled-type heat exchanger to cool the heat emitting part with a liquid refrigerant; and
an air-cooled-type heat exchanger to receive a refrigerant at a first temperature from the liquid-cooled-type heat exchanger, to air-cool the refrigerant, to a second temperature lower than the first and to supply the refrigerant with at the second temperature to the liquid-cooled-type heat exchanger.

14. The battery cooling system of claim 13, wherein the refrigerant in the liquid-cooled-type heat exchanger is in direct contact with the heat emitting part.

15. The battery cooling system of claim 13, wherein the heat emitting part is in contact with an external side surface of the liquid-cooled-type heat exchanger in which the refrigerant flows.

16. The battery cooling system of claim 13, wherein the plurality of battery cells and the plurality of heat pipes are soaked in the refrigerant in the liquid-cooled-type heat exchanger.
